(19) United States
(12) Patent Application Publication
(10) Pub. No.: US 2010/0302138 A1
(43) Pub. Date: Dec. 2, 2010

(54) METHODS AND SYSTEMS FOR DEFINING OR MODIFYING A VISUAL REPRESENTATION

(75) Inventors: Rudy Jacobus Poot, Clyde Hill, WA (US); Brian Eugene Keane, San Jose, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/475,297

(22) Filed: May 29, 2009

(51) Int. Cl. G09G 5/00; H04N 7/18

(52) U.S. Cl. 345/156; 348/143

(57) ABSTRACT

A system may track a user's motions or gestures performed in a physical space and map them to a visual representation of the user. The user's gestures may be translated to a control in a system or application space, such as to open a file or to execute a punch in a punching game. Similarly, the user's gestures may be translated to a control in the system or application space for making modifications to a visual representation. A visual representation may be a display of a virtual object or a display that maps to a target in the physical space. In another example embodiment, the system may track the target in the physical space over time and apply modifications or updates to the visual representation based on the history data.

### BACKGROUND

Many computing applications such as computer games, multimedia applications, office applications, or the like use controls to allow users to manipulate game characters or other aspects of an application. Typically such controls are input using, for example, controllers, remotes, keyboards, mice, or the like. Unfortunately, such controls can be difficult to learn, thus creating a barrier between a user and such games and applications. Furthermore, such controls may be different than actual game actions or other application actions for which the controls are used. For example, a game control that causes a game character to swing a baseball bat may not correspond to an actual motion of swinging the baseball bat.

### SUMMARY

A monitor may display a visual representation that maps to a target in a physical space, where image data corresponding to the target has been captured by the system. For example, the system may capture image data of a user in a physical space and provide a visual representation of the user such as in the form of an avatar. Similarly, the system may capture image data of objects in the physical space and display a virtual object to represent the object. Rather than simply selecting pre-packaged features for the characteristics of a user's avatar, it may be desirable to customize the visual representation of the user based on the actual characteristics of the user. For example, the capture device may detect physical features of the user and customize the user's avatar based on those detected features, such as eye shape, nose shape, clothing, accessories, or the like.

It may be desirable that the system allow the user to interact with the onscreen visual representations to change proportions, customize appearance, etc. In an example embodiment, a user may perform gestures in the physical space that correspond to modifications of the visual representation. For example, the system may track a user's motions or gestures performed in a physical space and map them to the visual representation for display purposes. The user's gestures may be translated to a control in a system or application space, such as to open a file or to execute a punch in a punching game. Similarly, the user's gestures may be translated to a control in the system or application space for making modifications to a visual representation. For example, a motion that comprises a user shaking an arm may be a gesture recognized for lengthening the arm of the user's visual representation or avatar.

In another example embodiment, the system may track the target in the physical space over time and apply modifications or updates to the visual representation based on the history data. For example, a capture device may track a user in the physical space and identify behaviors and mannerisms, emotions, speech patterns, or the like, and apply them to the user's avatar.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for modifying a visual representation in accordance with this specification are further described with reference to the accompanying drawings in which:

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system and incorporate chaining and animation blending techniques.

FIG. 3 illustrates an example embodiment of a computing environment in which the animation techniques described herein may be embodied.

FIG. 4 illustrates another example embodiment of a computing environment in which the animation techniques described herein may be embodied.

FIG. 5A illustrates a skeletal mapping of a user that has been generated from a depth image.

FIG. 5B illustrates further details of the gesture recognizer architecture shown in FIG. 2.

FIG. 6A-6E depict an example target recognition, analysis, and tracking system and example embodiments of various modification gestures.

FIG. 7 depicts an example target recognition, analysis, and tracking system for entering into a modification mode.

FIG. 8 depicts an example flow diagram for a method of applying a modification to a visual representation of a target.

### DETAILED DESCRIPTION OF ILLUSTRATIVE EMBODIMENTS

A computing system can model and display a visual representation of a target in a physical space, such as a human target or object. The system may comprise a capture device that captures image data of a scene and a monitor that displays a visual representation that corresponds to a target in the scene. For example, a camera-controlled computing system may capture target image data, generate a model of the target, and display a visual representation of that model. The system may track the target in the physical space such that the visual representation maps to the target or the motion captured in the physical space. Thus, the motion of the visual representation can be controlled by mapping the movement of the visual representation to the motion of the target in the physical space. For example, the target may be a human user that is motioning or gesturing in the physical space. The visual representation of the target may be an avatar displayed on a screen, and the avatar's motion may correspond to the user's motion.

Motion in the physical space may be translated to a control in a system or application space, such as a virtual space and/or a game space. For example, a user's motions may be tracked, modeled, and displayed, and the user's gestures may control certain aspects of an operating system or executing application. The user's gestures may be translated to a control in the system or application space for making modifications to a visual representation.

Disclosed herein are techniques for initializing and customizing an avatar based on the data captured by the capture device. The visual representation of the user may be in the form of an avatar, a cursor on the screen, a hand, or the any other virtual object that corresponds to the user in the physical space. It may be desirable to initialize and/or customize a visual representation based on actual characteristics of a target. For example, the capture device may identify physical features of a user and customize the user's avatar based on those identified features, such as eye shape, nose shape, clothing, accessories. In another example embodiment, modifications to a visual representation may correspond to a user's gestures in the physical space that are recognized as controls for modifying the visual representation in the virtual space.

The system may track the user and any motion in the physical space over time and apply modifications or updates to the avatar based on the history of the tracked data. For example, the capture device may identify behaviors and mannerisms, emotions, speech patterns, or the like, of a user and apply these to the user's avatar. Aspects of a skeletal or mesh model of a person may be generated based on the image data captured by the capture device to represent the user's body type, bone structure, height, weight, or the like.

To generate a model representative of a target or object in a physical space, a capture device can capture a depth image of the scene and scan targets or objects in the scene. In one embodiment, the capture device may determine whether one or more targets or objects in the scene corresponds to a human target such as the user. To determine whether a target or object in the scene corresponds a human target, each of the targets may be flood filled and compared to a pattern of a human body model. Each target or object that matches the human body model may then be scanned to generate a skeletal model associated therewith. For example, a target identified as a human may be scanned to generate a skeletal model associated therewith. The skeletal model may then be provided to the computing environment for tracking the skeletal model and rendering an avatar associated with the skeletal model. The computing environment may determine which controls to perform in an application executing on the computer environment based on, for example, gestures of the user that have been recognized and mapped to the skeletal model. Thus, user feedback may be displayed, such as via an avatar on a screen, and the user can control that avatar's motion by making gestures in the physical space.

Captured motion may be any motion in the physical space that is captured by the capture device, such as a camera. The captured motion could include the motion of a target in the physical space, such as a user or an object. The captured motion may include a gesture that translates to a control in an operating system or application. The motion may be dynamic, such as a running motion, or the motion may be static, such as a user that is posed with little movement.

The system, methods, and components of avatar creation and customization described herein may be embodied in a multi-media console, such as a gaming console, or in any other computing device in which it is desired to display a visual representation of a target, including, by way of example and without any intended limitation, satellite receivers, set top boxes, arcade games, personal computers (PCs), portable telephones, personal digital assistants (PDAs), and other hand-held devices.

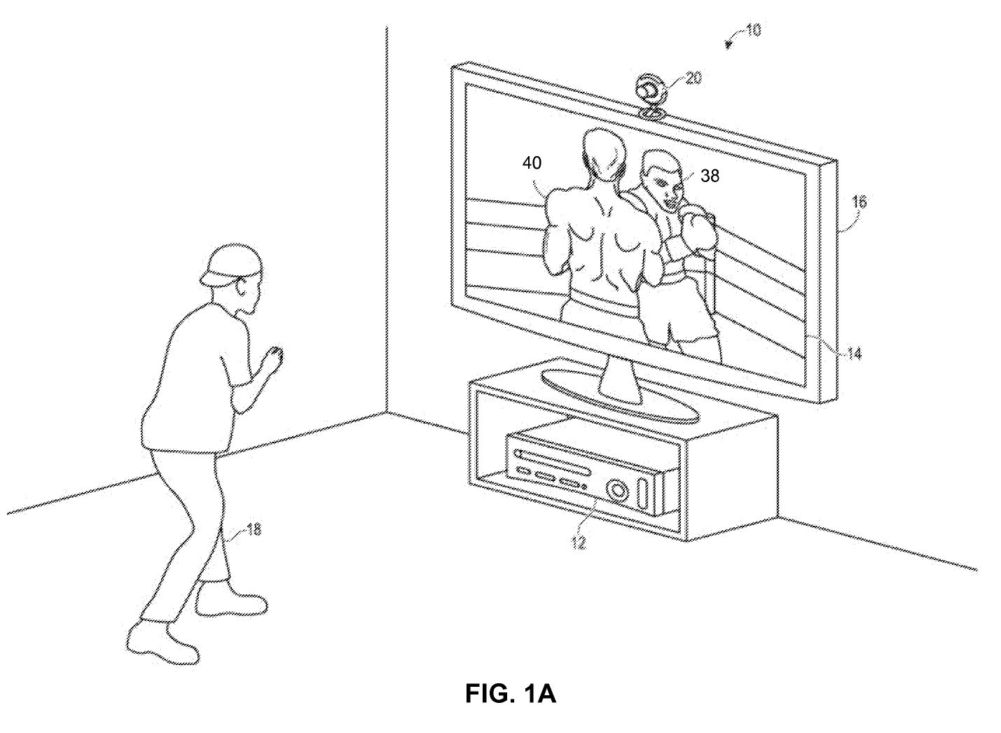

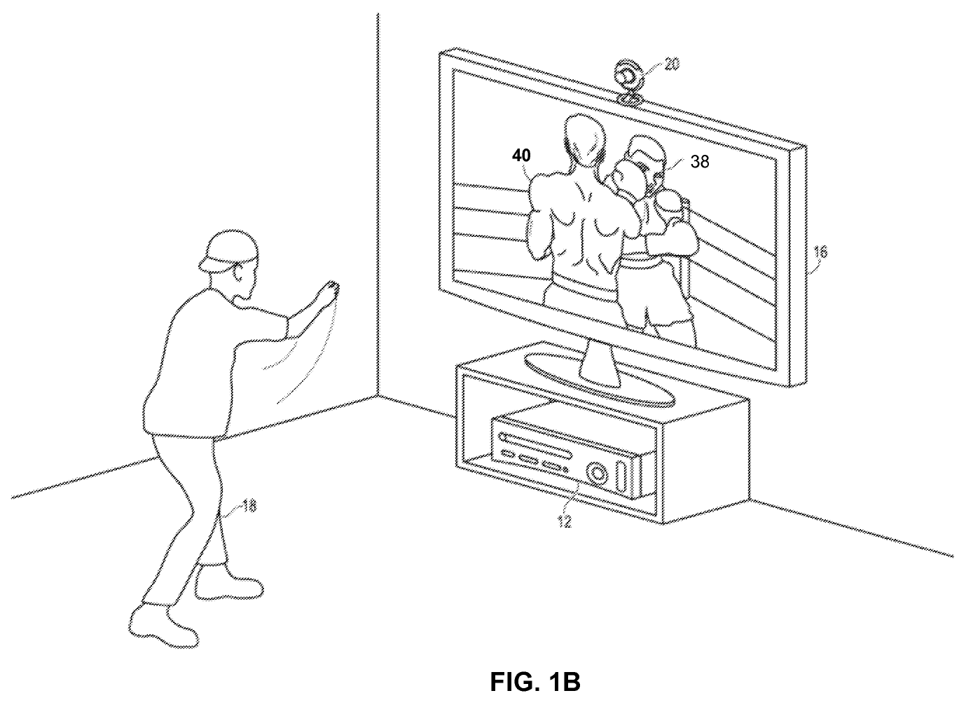

FIGS. 1A and 1B illustrate an example embodiment of a configuration of a target recognition, analysis, and tracking system 10 that may employ techniques for modifying aspects of captured motion that may, in turn, modify the animation of the captured motion. In the example embodiment, a user 18 playing a boxing game. In an example embodiment, the system 10 may recognize, analyze, and/or track a human target such as the user 18. The system 10 may gather information related to the user's gestures in the physical space.

As shown in FIG. 1A, the target recognition, analysis, and tracking system 10 may include a computing environment 12. The computing environment 12 may be a computer, a gaming system or console, or the like. According to an example embodiment, the computing environment 12 may include hardware components and/or software components such that the computing environment 12 may be used to execute applications such as gaming applications, non-gaming applications, or the like.

As shown in FIG. 1A, the target recognition, analysis, and tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions within an application, as will be described in more detail below.

According to one embodiment, the target recognition, analysis, and tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the target recognition, analysis, and tracking system 10 may be used to recognize, analyze, and/or track a human target such as the user 18. For example, the user 18 may be tracked using the capture device 20 such that the movements of user 18 may be interpreted as controls that may be used to affect the application being executed by computer environment 12. Thus, according to one embodiment, the user 18 may move his or her body to control the application.

The system 10 may translate an input to a capture device 20 into an animation, the input being representative of a user's motion, such that the animation is driven by that input. Thus, the user's motions may map to an avatar 40 such that the user's motions in the physical space are performed by the avatar 40. The user's motions may be gestures that are applicable to a control in an application. As shown in FIGS. 1A and 1B, in an example embodiment, the application executing on the computing environment 12 may be a boxing game that the user 18 may be playing.

The computing environment 12 may use the audiovisual device 16 to provide a visual representation of a player avatar 40 that the user 18 may control with his or her movements. For example, as shown in FIG. 1B, the user 18 may throw a punch in physical space to cause the player avatar 40 to throw a punch in game space. The player avatar 40 may have the characteristics of the user identified by the capture device 20, or the system 10 may use the features of a well-known boxer or portray the physique of a professional boxer for the visual representation that maps to the user's motions. The computing environment 12 may also use the audiovisual device 16 to provide a visual representation of a boxing opponent 38 to the user 18. According to an example embodiment, the computer environment 12 and the capture device 20 of the target recognition, analysis, and tracking system 10 may be used to recognize and analyze the punch of the user 18 in physical space such that the punch may be interpreted as a game control of the player avatar 40 in game space. Multiple users can interact with each other from remote locations. For example, the visual representation of the boxing opponent 38 may be representative of another user, such as a second user in the physical space with user 18 or a networked user in a second physical space.

Other movements by the user 18 may also be interpreted as other controls or actions, such as controls to bob, weave, shuffle, block, jab, or throw a variety of different power punches. Furthermore, some movements may be interpreted as controls that may correspond to actions other than controlling the player avatar 40. For example, the player may use movements to end, pause, or save a game, select a level, view high scores, communicate with a friend, etc. Additionally, a full range of motion of the user 18 may be available, used, and analyzed in any suitable manner to interact with an application.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

A user's gestures or motion may be interpreted as controls that may correspond to actions other than controlling the player avatar 40. For example, the player may use movements to end, pause, or save a game, select a level, view high scores, communicate with a friend, etc. The player may use movements to apply modifications to the avatar. For example, the user may shake his or her arm in the physical space and this may be a gesture identified by the system 10 as a request to make the avatar's arm longer. Virtually any controllable aspect of an operating system and/or application may be controlled by movements of the target such as the user 18. According to other example embodiments, the target recognition, analysis, and tracking system 10 may interpret target movements for controlling aspects of an operating system and/or application that are outside the realm of games. A modification of the user's avatar in a non-gaming application may be an aspect of the operating system and/or application that can be controlled by the user's gestures. For example, in a spreadsheet application the visual representation of the user may be a hand symbol. The user may make a motion in the physical space that corresponds to a gesture for making the hand larger, selecting a different symbol such as an arrow, changing the skin color of the hand, applying fingernail polish to the fingernails, or any other desired modification.

The user's gesture may be controls applicable to an operating system, non-gaming aspects of a game, or a non-gaming application. The user's gestures may be interpreted as object manipulation, such as controlling a user interface. For example, consider a user interface having blades or a tabbed interface lined up vertically left to right, where the selection of each blade or tab opens up the options for various controls within the application or the system. The system may identify the user's hand gesture for movement of a tab, where the user's hand in the physical space is virtually aligned with a tab in the application space. The gesture, including a pause, a grabbing motion, and then a sweep of the hand to the left, may be interpreted as the selection of a tab, and then moving it out of the way to open the next tab.

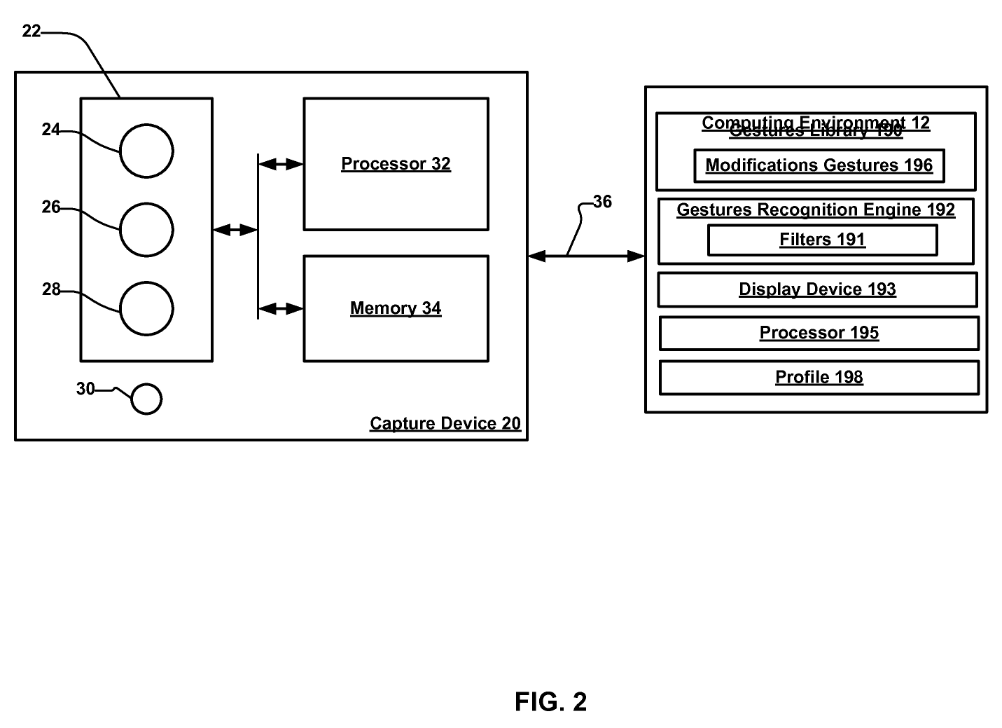

FIG. 2 illustrates an example embodiment of a capture device 20 that may be used for target recognition, analysis, and tracking, where the target can be a user or an object. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information

The capture device 20 may further include a microphone 30, or an array of microphones. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-d camera 26 or RGB camera 28, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. The computing environment 12 may then use the skeletal model, depth information, and captured images to, for example, control an application such as a game or word processor. For example, as shown, in FIG. 2, the computing environment 12 may include a gestures library 190.

As shown, in FIG. 2, the computing environment 12 may include a gestures library 190 and a gestures recognition engine 192. The gestures recognition engine 192 may include a collection of gesture filters 191. Each filter 191 may comprise information defining a gesture along with parameters, or metadata, for that gesture. For instance, a throw, which comprises motion of one of the hands from behind the rear of the body to past the front of the body, may be implemented as a gesture filter 191 comprising information representing the movement of one of the hands of the user from behind the rear of the body to past the front of the body, as that movement would be captured by a depth camera. Parameters may then be set for that gesture. Where the gesture is a throw, a parameter may be a threshold velocity that the hand has to reach, a distance the hand must travel (either absolute, or relative to the size of the user as a whole), and a confidence rating by the recognizer engine that the gesture occurred. These parameters for the gesture may vary between applications, between contexts of a single application, or within one context of one application over time.

A gesture may be recognized as a request for avatar modification. In an example embodiment, the motion in the physical space may be representative of a gesture recognized as a request to modify the visual representation of a target. A plurality of gestures may each represent a particular modification. Thus, a user can control the form of the visual representation by making a gesture in the physical space that is recognized as a modification gesture. For example, as described above, the user's motion may be compared to a gesture filter, such as gesture filter 191 from FIG. 2. The gesture filter 191 may comprise information for a modification gesture from the modifications gestures 196 in the gestures library 190.

A plurality of modifications gestures may each represent a modification to a visual representation on the screen. For example, a limb stretching modification gesture may be recognized from the identity of a user's motion comprising shaking out a limb, such as an arm. The user can use momentum and quickly snap the user's arm, and the gesture will cause a limb of the visual representation of the user, such as an avatar, to stretch. In another example, the gesture may be a shifting volume gesture. The user may motion by squashing the user's belly from the left and right. The shifting volume modification gesture identified from the motion may result in shifting excess volume of the avatar from the legs and stomach up into the chest. The result may be an avatar with a muscular chest. Another example of a modification gesture is a squashing head gesture. The user may make a squashing gesture around the base of his or her head. The corresponding squashing head modification gesture may be recognized, and result in displacing the volume of the avatar's head into a long shape, giving the avatar an elongated and skinnier head.

In another example embodiment, the gesture may be recognized as a trigger for entry into a modification mode. For example, a gesture filter 191 may comprise information for recognizing a modification trigger gesture from the modifications gestures 196. If the modification trigger gesture is recognized, the application may go into a modification mode. The modification trigger gesture may vary between applications, between systems, between users, or the like. For example, the same gesture in a tennis gaming application may not be the same modification trigger gesture in a bowling game application. Consider an example modification trigger gesture that comprises a user motioning the user's right hand, presented in front of the user's body, with the pointer finger pointing upward and moving in a circular motion. The parameters set for the modification trigger gesture may be used to identify that the user's hand is in front of the body, the user's pointer finger is pointed in an upward motion, and identifying that the pointer finger is moving in a circular motion.

Certain gestures may be identified as a request to enter into a modification mode, where if an application is currently executing, the modification mode interrupts the current state of the application and enters into a modification mode. The modification mode may cause the application to pause, where the application can be resumed at the pause point when the user leaves the modification mode. Alternately, the modification mode may not result in a pause to the application, and the application may continue to execute while the user makes modifications.

Following entry in the modification mode, the system may recognize a plurality of modification gestures, each representing a particular modification. For example, depending on the number of modifications and gestures that are applicable system-wide or for a particular application, it may be desirable to have numerous modification trigger gestures. Each modification trigger gesture may trigger entry into a modification mode, packaged with an independent set of gestures that correspond to the modification mode entered into as a result of the modification trigger gesture. The package could be a system-wide package, an application-specific package, or a gesture-specific package. A different modification trigger gesture could be used for entry into an application-specific modification mode versus a system-wide modification mode.

With such a variety of possible desired modifications, gestures may be defined similarly but still be independently and correctly identified or recognized depending on the modification mode the user has entered. For example, consider a modification trigger gesture that comprises the user's motion of pinching the user's shirt in the physical space and tugging on the shirt a few times. The modification mode entered in to may be specific to clothing modifications, or even just shirt or upper body modifications. Thus, a whole package of modification gestures may be used in the mode for modifying clothing or the upper body. Another modification trigger gesture may be the user's hand waving in front of the user's face, where the package of modifications that are available upon entry into the modification mode may be specific to facial features.

Once in the modification mode, the user's visual representation may change into a cursor or hand-selection display. The cursor, for example, may correspond to the tracked motions of the user's hand in the physical space, and the user may use gestures for making selections for modification to the avatar based on available options. For example, a tennis gaming application may come with options to select different rackets or a different logo on the avatar's clothes, or the options may be to change the visual representation of the user to have the physique and likeliness of a well-known tennis player. The user's gesture may comprise a clutching motion in line with a visual representation of the modification, such that the modification is applied upon recognition of the clutching motion, for example.

The data captured by the cameras 26, 28 and device 20 in the form of the skeletal model and movements associated with it may be compared to the gesture filters 191 in the gesture library 190 to identify when a user (as represented by the skeletal model) has performed one or more gestures. Thus, inputs to a filter such as filter 191 may comprise things such as joint data about a user's joint position, like angles formed by the bones that meet at the joint, RGB color data from the scene, and the rate of change of an aspect of the user. As mentioned, parameters may be set for the gesture. Outputs from a filter 191 may comprise things such as the confidence that a given gesture is being made, the speed at which a gesture motion is made, and a time at which the gesture occurs.

The computing environment 12 may include a processor 195 that can process the depth image to determine what targets are in a scene, such as a user 18 or an object in the room. This can be done, for instance, by grouping together of pixels of the depth image that share a similar distance value. The image may also be parsed to produce a skeletal representation of the user, where features, such as joints and tissues that run between joints are identified. There exist skeletal mapping techniques to capture a person with a depth camera and from that determine various spots on that user's skeleton, joints of the hand, wrists, elbows, knees, nose, ankles, shoulders, and where the pelvis meets the spine. Other techniques include transforming the image into a body model representation of the person and transforming the image into a mesh model representation of the person.

In an embodiment, the processing is performed on the capture device 20 itself, and the raw image data of depth and color (where the capture device 20 comprises a 3D camera 26) values are transmitted to the computing environment 12 via link 36. In another embodiment, the processing is performed by a processor 32 coupled to the camera 402 and then the parsed image data is sent to the computing environment 12. In still another embodiment, both the raw image data and the parsed image data are sent to the computing environment 12. The computing environment 12 may receive the parsed image data but it may still receive the raw data for executing the current process or application. For instance, if an image of the scene is transmitted across a computer network to another user, the computing environment 12 may transmit the raw data for processing by another computing environment.

The computing environment 12 may use the gestures library 190 to interpret movements of the skeletal model and to control an application based on the movements. The computing environment 12 can model and display a representation of a user, such as in the form of an avatar or a pointer on a display, such as in a display device 193. Display device 193 may include a computer monitor, a television screen, or any suitable display device. For example, a camera-controlled computer system may capture user image data and display user feedback on a television screen that maps to the user's gestures. The user feedback may be displayed as an avatar on the screen such as shown in FIGS. 1A and 1B. The avatar's motion can be controlled directly by mapping the avatar's movement to those of the user's movements. The user's gestures may be interpreted control certain aspects of the application.

As described above, it may be desirable to modify aspects of a target's visual representation. For example, a user may wish to modify aspects of a skeletal or mesh model of a person that is generated based on the image data captured by the capture device 20. The modification may be made to the model. For example, certain joints of the skeletal model may be readjusted or realigned. The user may initiate the modification by performing a particular gesture. For example, a particular gesture may cause a modification to the visual representation, such as making an avatar of the user taller or making a virtual ball larger. The gesture may cause the modification during the execution of an application, or the gesture may trigger entry into a modification mode.

According to an example embodiment, the target may be a human target in any position such as standing or sitting, a human target with an object, two or more human targets, one or more appendages of one or more human targets or the like that may be scanned, tracked, modeled and/or evaluated to generate a virtual screen, compare the user to one or more stored profiles and/or to store profile information 198 about the target in a computing environment such as computing environment 12. The profile information 198 may be in the form of user profiles, personal profiles, application profiles, system profiles, or any other suitable method for storing data for later access. The profile information 198 may be accessible via an application or be available system-wide, for example. The profile information 198 may include lookup tables for loading specific user profile information. The virtual screen may interact with an application that may be executed by the computing environment 12 described above with respect to FIGS. 1A-1B.

According to example embodiments, lookup tables may include user specific profile information. In one embodiment, the computing environment such as computing environment 12 may include stored profile data 198 about one or more users in lookup tables. The stored profile data 198 may include, among other things the targets scanned or estimated body size, skeletal models, body models, voice samples or passwords, the targets age, previous gestures, target limitations and standard usage by the target of the system, such as, for example a tendency to sit, left or right handedness, or a tendency to stand very near the capture device. This information may be used to determine if there is a match between a target in a capture scene and one or more user profiles 198, that, in one embodiment, may allow the system to adapt the virtual screen to the user, or to adapt other elements of the computing or gaming experience according to the profile 198.

One or more personal profiles 198 may be stored in computer environment 12 and used in a number of user sessions, or one or more personal profiles may be created for a single session only. Users may have the option of establishing a profile where they may provide information to the system such as a voice or body scan, age, personal preferences, right or left handedness, an avatar, a name or the like. Personal profiles may also be provided for “guests” who do not provide any information to the system beyond stepping into the capture space. A temporary personal profile may be established for one or more guests. At the end of a guest session, the guest personal profile may be stored or deleted.

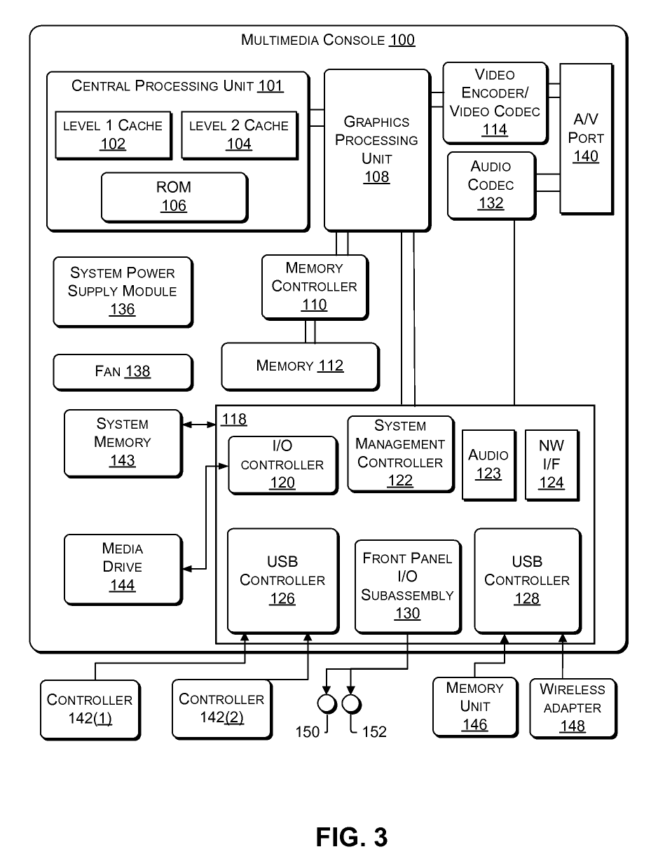

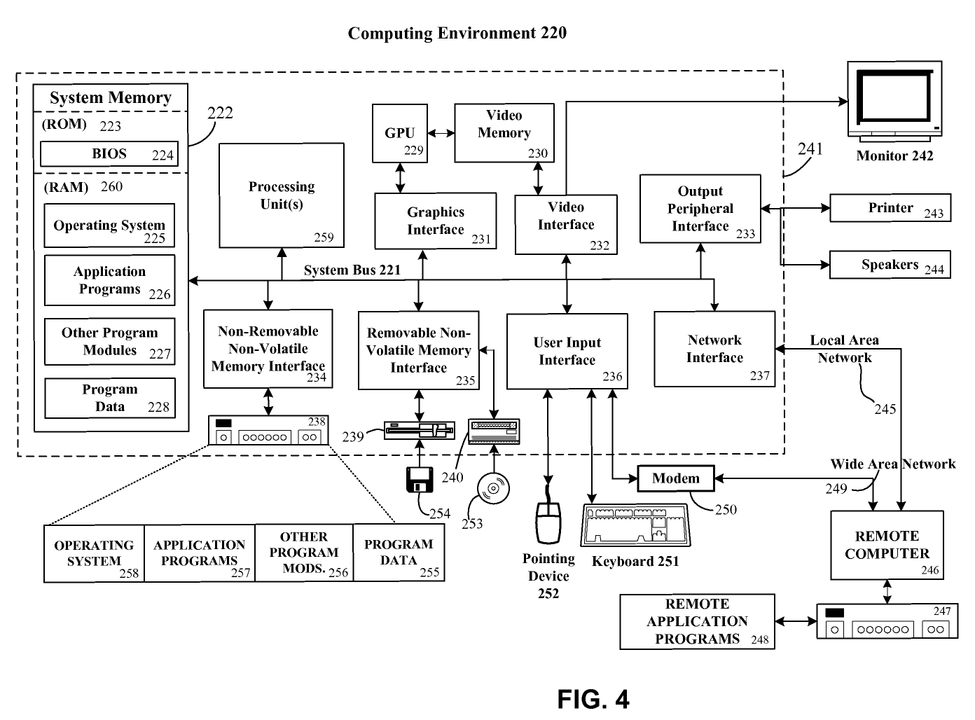

The gestures library 190, gestures recognition engine 192, and profile 198 may be implemented in hardware, software or a combination of both. For example, the gestures library 190,and gestures recognition engine 192 may be implemented as software that executes on a processor, such as processor 195, of the computing environment 12 (or on processing unit 101 of FIG. 3 or processing unit 259 of FIG. 4).

It is emphasized that the block diagram depicted in FIGS. 2 and FIGS. 3-4 described below are exemplary and not intended to imply a specific implementation. Thus, the processor 195 or 32 in FIG. 1, the processing unit 101 of FIG. 3, and the processing unit 259 of FIG. 4, can be implemented as a single processor or multiple processors. Multiple processors can be distributed or centrally located. For example, the gestures library 190 may be implemented as software that executes on the processor 32 of the capture device or it may be implemented as software that executes on the processor 195 in the computing environment 12. Any combination of processors that are suitable for performing the techniques disclosed herein are contemplated. Multiple processors can communicate wirelessly, via hard wire, or a combination thereof.

Furthermore, as used herein, a computing environment 12 may refer to a single computing device or to a computing system. The computing environment may include non-computing components. The computing environment may include a display device, such as display device 193 shown in FIG. 2. A display device may be an entity separate but coupled to the computing environment or the display device may be the computing device that processes and displays, for example. Thus, a computing system, computing device, computing environment, computer, processor, or other computing component may be used interchangeably.

The gestures library and filter parameters may be tuned for an application or a context of an application by a gesture tool. A context may be a cultural context, and it may be an environmental context. A cultural context refers to the culture of a user using a system. Different cultures may use similar gestures to impart markedly different meanings. For instance, an American user who wishes to tell another user to “look” or “use his eyes” may put his index finger on his head close to the distal side of his eye. However, to an Italian user, this gesture may be interpreted as a reference to the mafia.

Similarly, there may be different contexts among different environments of a single application. Take a first-user shooter game that involves operating a motor vehicle. While the user is on foot, making a first with the fingers towards the ground and extending the first in front and away from the body may represent a punching gesture. While the user is in the driving context, that same motion may represent a “gear shifting” gesture. With respect to modifications to the visual representation, different gestures may trigger different modifications depending on the environment. A different modification trigger gesture could be used for entry into an application-specific modification mode versus a system-wide modification mode. Each modification mode may be packaged with an independent set of gestures that correspond to the modification mode, entered into as a result of the modification trigger gesture. For example, in a bowling game, a swinging arm motion may be a gesture identified as swinging a bowling ball for release down a virtual bowling alley. However, in another application, the swinging arm motion may be a gesture identified as a request to lengthen the arm of the user's avatar displayed on the screen. There may also be one or more menu environments, where the user can save his game, select among his character's equipment or perform similar actions that do not comprise direct game-play. In that environment, this same gesture may have a third meaning, such as to select something or to advance to another screen.

Gestures may be grouped together into genre packages of complimentary gestures that are likely to be used by an application in that genre. Complimentary gestures—either complimentary as in those that are commonly used together, or complimentary as in a change in a parameter of one will change a parameter of another—may be grouped together into genre packages. These packages may be provided to an application, which may select at least one. The application may tune, or modify, the parameter of a gesture or gesture filter 191 to best fit the unique aspects of the application. When that parameter is tuned, a second, complimentary parameter (in the inter-dependent sense) of either the gesture or a second gesture is also tuned such that the parameters remain complimentary. Genre packages for video games may include genres such as first-user shooter, action, driving, and sports.

FIG. 3 illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs.), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100.

FIG. 4 illustrates another example embodiment of a computing environment 220 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

The computer readable storage medium may comprise computer readable instructions for modifying a visual representation. The instructions may comprise instructions for rendering the visual representation, receiving data of a scene, wherein the data includes data representative of a user's modification gesture in a physical space, and modifying the visual representation based on the user's modification gesture, wherein the modification gesture is a gesture that maps to a control for modifying a characteristic of the visual representation.

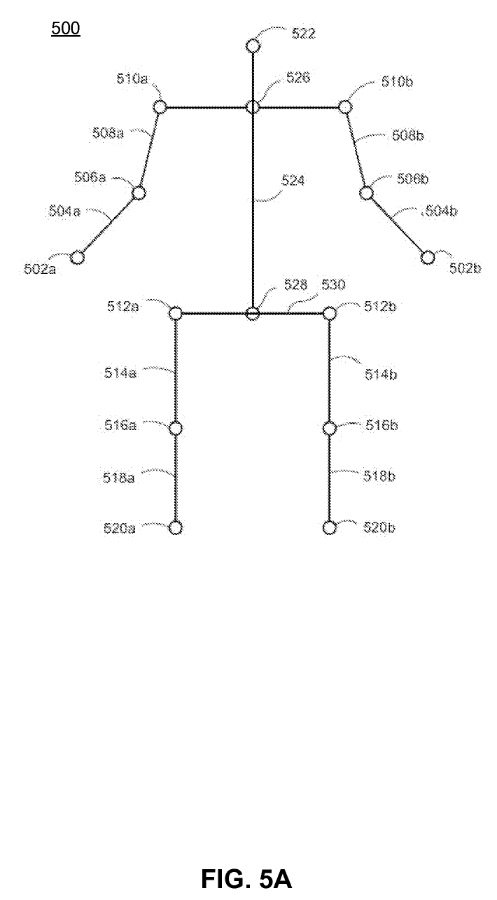

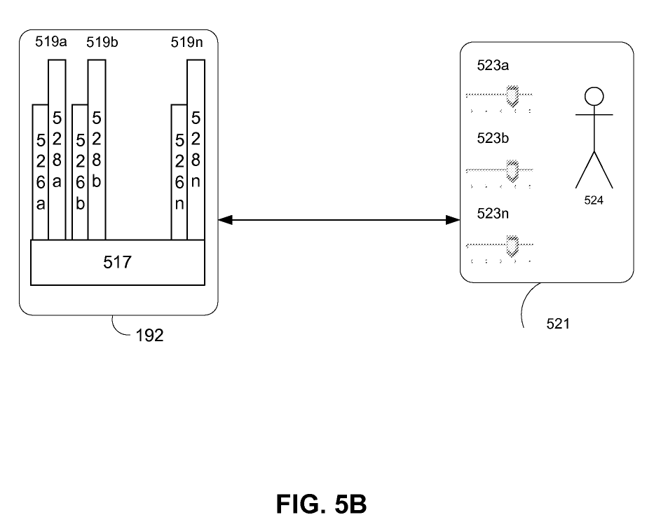

FIG. 5A depicts an example skeletal mapping of a user that may be generated from image data captured by the capture device 20. In this embodiment, a variety of joints and bones are identified: each hand 502, each forearm 504, each elbow 506, each bicep 508, each shoulder 510, each hip 512, each thigh 514, each knee 516, each foreleg 518, each foot 520, the head 522, the torso 524, the top 526 and bottom 528 of the spine, and the waist 530. Where more points are tracked, additional features may be identified, such as the bones and joints of the fingers or toes, or individual features of the face, such as the nose and eyes.

Through moving his body, a user may create gestures. A gesture comprises a motion or pose by a user that may be captured as image data and parsed for meaning. A gesture may be dynamic, comprising a motion, such as mimicking throwing a ball. A gesture may be a static pose, such as holding one's crossed forearms 504 in front of his torso 524. A gesture may also incorporate props, such as by swinging a mock sword. A gesture may comprise more than one body part, such as clapping the hands 502 together, or a subtler motion, such as pursing one's lips.

A user's gestures may be used for input in a general computing context. For instance, various motions of the hands 502 or other body parts may correspond to common system wide tasks such as navigate up or down in a hierarchical list, open a file, close a file, and save a file. For instance, a user may hold his hand with the fingers pointing up and the palm facing the capture device 20. He may then close his fingers towards the palm to make a first, and this could be a gesture that indicates that the focused window in a window-based user-interface computing environment should be closed. Gestures may also be used in a video-game-specific context, depending on the game. For instance, with a driving game, various motions of the hands 502 and feet 520 may correspond to steering a vehicle in a direction, shifting gears, accelerating, and braking. Thus, a gesture may indicate a wide variety of motions that map to a displayed user representation, and in a wide variety of applications, such as video games, text editors, word processing, data management, etc.

A user may generate a gesture that corresponds to walking or running, by walking or running in place himself. For example, the user may alternately lift and drop each leg 512-520 to mimic walking without moving. The system may parse this gesture by analyzing each hip 512 and each thigh 514. A step may be recognized when one hip-thigh angle (as measured relative to a vertical line, wherein a standing leg has a hip-thigh angle of 0°, and a forward horizontally extended leg has a hip-thigh angle of 90°) exceeds a certain threshold relative to the other thigh. A walk or run may be recognized after some number of consecutive steps by alternating legs. The time between the two most recent steps may be thought of as a period. After some number of periods where that threshold angle is not met, the system may determine that the walk or running gesture has ceased.

Given a “walk or run” gesture, an application may set values for parameters associated with this gesture. These parameters may include the above threshold angle, the number of steps required to initiate a walk or run gesture, a number of periods where no step occurs to end the gesture, and a threshold period that determines whether the gesture is a walk or a run. A fast period may correspond to a run, as the user will be moving his legs quickly, and a slower period may correspond to a walk.

A gesture may be associated with a set of default parameters at first that the application may override with its own parameters. In this scenario, an application is not forced to provide parameters, but may instead use a set of default parameters that allow the gesture to be recognized in the absence of application-defined parameters. Information related to the gesture may be stored for purposes of pre-canned animation.

There are a variety of outputs that may be associated with the gesture. There may be a baseline “yes or no” as to whether a gesture is occurring. There also may be a confidence level, which corresponds to the likelihood that the user's tracked movement corresponds to the gesture. This could be a linear scale that ranges over floating point numbers between 0 and 1, inclusive. Wherein an application receiving this gesture information cannot accept false-positives as input, it may use only those recognized gestures that have a high confidence level, such as at least 0.95. Where an application must recognize every instance of the gesture, even at the cost of false-positives, it may use gestures that have at least a much lower confidence level, such as those merely greater than 0.2. The gesture may have an output for the time between the two most recent steps, and where only a first step has been registered, this may be set to a reserved value, such as −1 (since the time between any two steps must be positive). The gesture may also have an output for the highest thigh angle reached during the most recent step.

Another exemplary gesture is a “heel lift jump.” In this, a user may create the gesture by raising his heels off the ground, but keeping his toes planted. Alternatively, the user may jump into the air where his feet 520 leave the ground entirely. The system may parse the skeleton for this gesture by analyzing the angle relation of the shoulders 510, hips 512 and knees 516 to see if they are in a position of alignment equal to standing up straight. Then these points and upper 526 and lower 528 spine points may be monitored for any upward acceleration. A sufficient combination of acceleration may trigger a jump gesture. A sufficient combination of acceleration with a particular gesture may satisfy the parameters of a transition point.

Given this “heel lift jump” gesture, an application may set values for parameters associated with this gesture. The parameters may include the above acceleration threshold, which determines how fast some combination of the user's shoulders 510, hips 512 and knees 516 must move upward to trigger the gesture, as well as a maximum angle of alignment between the shoulders 510, hips 512 and knees 516 at which a jump may still be triggered. The outputs may comprise a confidence level, as well as the user's body angle at the time of the jump.

Setting parameters for a gesture based on the particulars of the application that will receive the gesture is important in accurately identifying gestures. Properly identifying gestures and the intent of a user greatly helps in creating a positive user experience.

An application may set values for parameters associated with various transition points to identify the points at which to use pre-canned animations. Transition points may be defined by various parameters, such as the identification of a particular gesture, a velocity, an angle of a target or object, or any combination thereof. If a transition point is defined at least in part by the identification of a particular gesture, then properly identifying gestures assists to increase the confidence level that the parameters of a transition point have been met.

Another parameter to a gesture may be a distance moved. Where a user's gestures control the actions of an avatar in a virtual environment, that avatar may be arm's length from a ball. If the user wishes to interact with the ball and grab it, this may require the user to extend his arm 502-510 to full length while making the grab gesture. In this situation, a similar grab gesture where the user only partially extends his arm 502-510 may not achieve the result of interacting with the ball. Likewise, a parameter of a transition point could be the identification of the grab gesture, where if the user only partially extends his arm 502-510, thereby not achieving the result of interacting with the ball, the user's gesture also will not meet the parameters of the transition point.

A gesture or a portion thereof may have as a parameter a volume of space in which it must occur. This volume of space may typically be expressed in relation to the body where a gesture comprises body movement. For instance, a football throwing gesture for a right-handed user may be recognized only in the volume of space no lower than the right shoulder 510a, and on the same side of the head 522 as the throwing arm 502a-310a. It may not be necessary to define all bounds of a volume, such as with this throwing gesture, where an outer bound away from the body is left undefined, and the volume extends out indefinitely, or to the edge of scene that is being monitored.

FIG. 5B provides further details of one exemplary embodiment of the gesture recognizer engine 192 of FIG. 2. As shown, the gesture recognizer engine 190 may comprise at least one filter 519 to determine a gesture or gestures. A filter 519 comprises information defining a gesture 526 (hereinafter referred to as a “gesture”), and may comprise at least one parameter 528, or metadata, for that gesture 526. For instance, a throw, which comprises motion of one of the hands from behind the rear of the body to past the front of the body, may be implemented as a gesture 526 comprising information representing the movement of one of the hands of the user from behind the rear of the body to past the front of the body, as that movement would be captured by the depth camera. Parameters 528 may then be set for that gesture 526. Where the gesture 526 is a throw, a parameter 528 may be a threshold velocity that the hand has to reach, a distance the hand must travel (either absolute, or relative to the size of the user as a whole), and a confidence rating by the recognizer engine 192 that the gesture 526 occurred. These parameters 528 for the gesture 526 may vary between applications, between contexts of a single application, or within one context of one application over time.

Filters may be modular or interchangeable. In an embodiment, a filter has a number of inputs, each of those inputs having a type, and a number of outputs, each of those outputs having a type. In this situation, a first filter may be replaced with a second filter that has the same number and types of inputs and outputs as the first filter without altering any other aspect of the recognizer engine 190 architecture. For instance, there may be a first filter for driving that takes as input skeletal data and outputs a confidence that the gesture 526 associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

A filter need not have a parameter 528. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Inputs to a filter may comprise things such as joint data about a user's joint position, like angles formed by the bones that meet at the joint, RGB color data from the scene, and the rate of change of an aspect of the user. Outputs from a filter may comprise things such as the confidence that a given gesture is being made, the speed at which a gesture motion is made, and a time at which a gesture motion is made.

A context may be a cultural context, and it may be an environmental context. A cultural context refers to the culture of a user using a system. Different cultures may use similar gestures to impart markedly different meanings. For instance, an American user who wishes to tell another user to “look” or “use his eyes” may put his index finger on his head close to the distal side of his eye. However, to an Italian user, this gesture may be interpreted as a reference to the mafia.

Similarly, there may be different contexts among different environments of a single application. Take a first-person shooter game that involves operating a motor vehicle. While the user is on foot, making a first with the fingers towards the ground and extending the first in front and away from the body may represent a punching gesture. While the user is in the driving context, that same motion may represent a “gear shifting” gesture. There may also be one or more menu environments, where the user can save his game, select among his character's equipment or perform similar actions that do not comprise direct game-play. In that environment, this same gesture may have a third meaning, such as to select something or to advance to another screen.

The gesture recognizer engine 190 may have a base recognizer engine 517 that provides functionality to a gesture filter 519. In an embodiment, the functionality that the recognizer engine 517 implements includes an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

Filters 519 are loaded and implemented on top of the base recognizer engine 517 and can utilize services provided by the engine 517 to all filters 519. In an embodiment, the base recognizer engine 517 processes received data to determine whether it meets the requirements of any filter 519. Since these provided services, such as parsing the input, are provided once by the base recognizer engine 517 rather than by each filter 519, such a service need only be processed once in a period of time as opposed to once per filter 519 for that period, so the processing required to determine gestures is reduced.

An application may use the filters 519 provided by the recognizer engine 190, or it may provide its own filter 519, which plugs in to the base recognizer engine 517. In an embodiment, all filters 519 have a common interface to enable this plug-in characteristic. Further, all filters 519 may utilize parameters 528, so a single gesture tool as described below may be used to debug and tune the entire filter system 519.

These parameters 528 may be tuned for an application or a context of an application by a gesture tool 521. In an embodiment, the gesture tool 521 comprises a plurality of sliders 523, each slider 523 corresponding to a parameter 528, as well as a pictorial representation of a body 524. As a parameter 528 is adjusted with a corresponding slider 523, the body 524 may demonstrate both actions that would be recognized as the gesture with those parameters 528 and actions that would not be recognized as the gesture with those parameters 528, identified as such. This visualization of the parameters 528 of gestures provides an effective means to both debug and fine tune a gesture.

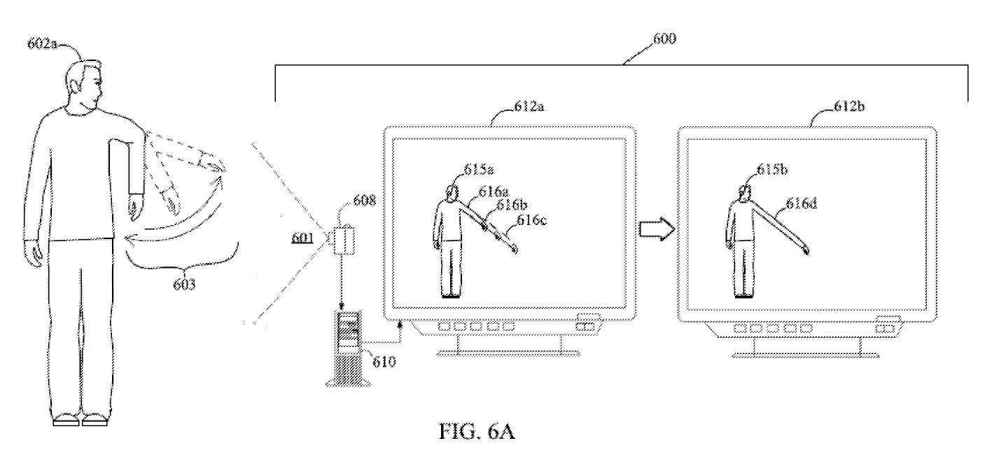

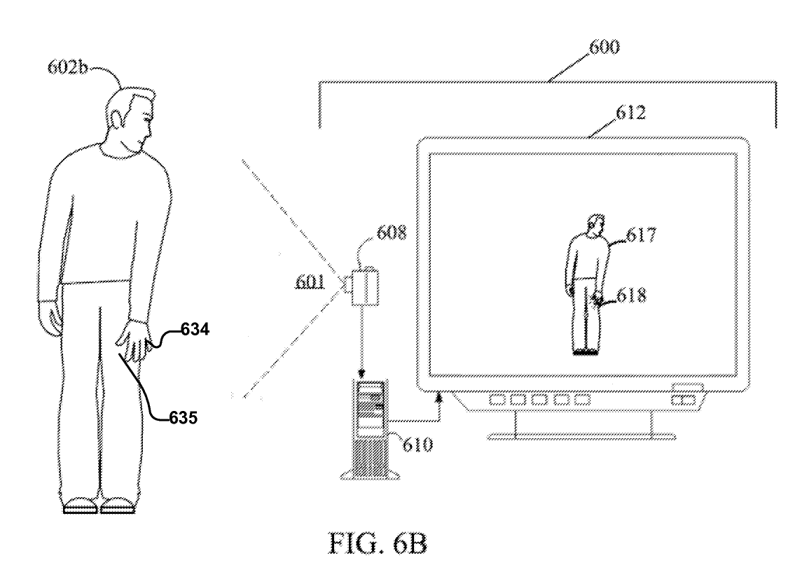

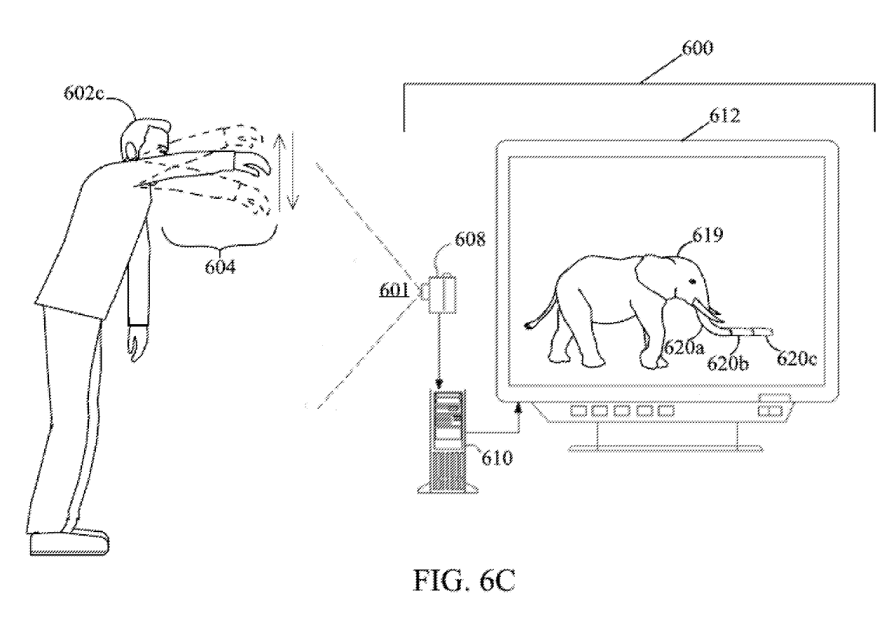

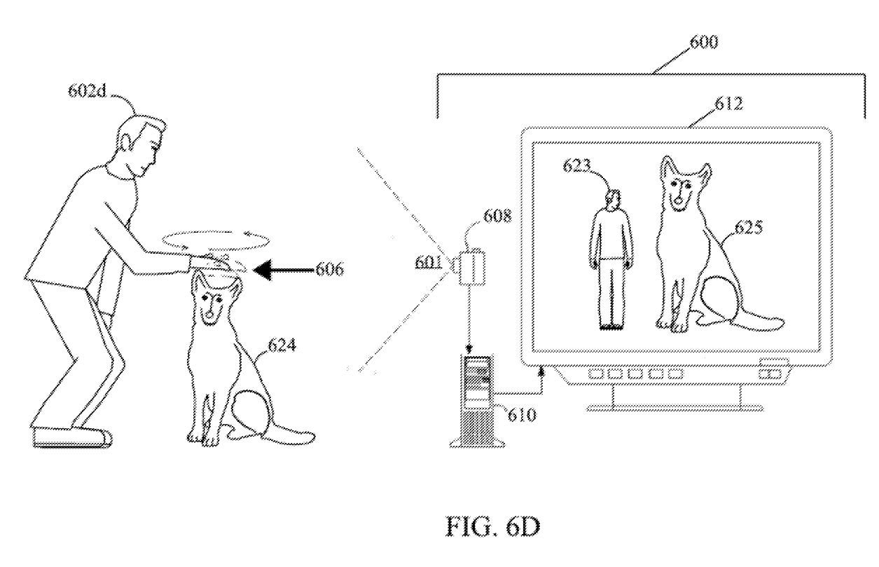

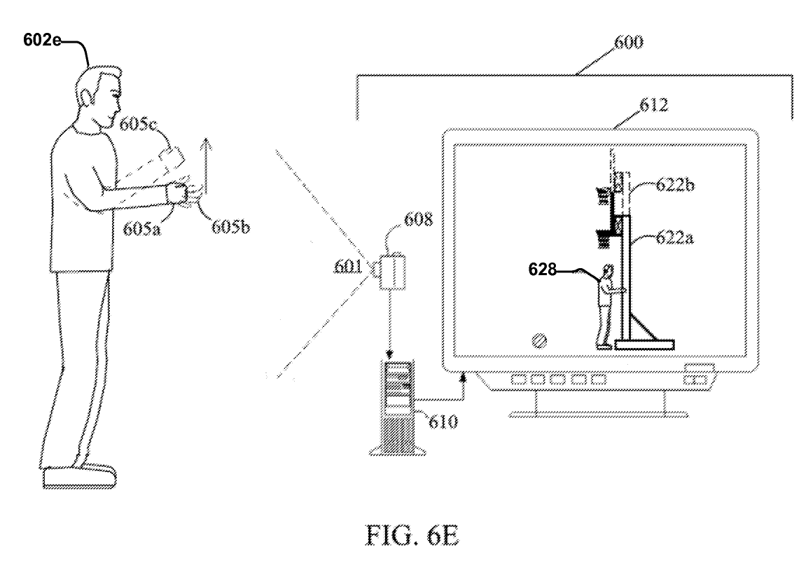

FIGS. 6A-6E illustrates an example of a system 600 that captures a target in a physical space 601 and maps it to a visual representation in a virtual environment. Examples of various gesture modifications are shown in FIGS. 6A-6E. The target may be any object or user in the physical space. As shown in FIGS. 6A-6E, system 600 may comprise a capture device 608, a computing device 610, and a display device 612. For example, the capture device 608, computing device 610, and display device 612 may comprise any suitable device that performs the desired functionality, such as the devices described with respect to FIGS. 1A-5B. It is contemplated that a single device may perform all of the functions in system 600, or any combination of suitable devices may perform the desired functions. For example, the computing device 610 may provide the functionality described with respect to the computing environment 12 shown in FIG. 2 or the computer in FIG. 3. As shown in FIG. 2, the computing environment 12 may include the display device and a processor. The computing device 610 may also comprise its own camera component or may be coupled to a device having a camera component, such as capture device 608.

FIGS. 6A-6E each represent the user's 602 motion at a discrete point in time and the display 612 displays a visual representation that corresponds to the user at that point of time. The reference to the user 602 is a general reference to the user depicted in each of FIGS. 6A-6E, namely user 602a, user 602b, user 602c, user 602d, and user 602e, respectively, each showing the user 602 performing a different gesture. The system 600 may identify a gesture from the user's motion by evaluating the user's position in a single frame of capture data or over a series of frames. The rate that frames of image data are captured and displayed determines the level of continuity of the displayed motion of the visual representation. Though additional frames of image data may be captured and displayed, the frame depicted in each of FIGS. 6A-6E is selected for exemplary purposes.

In these examples, a depth camera 608 captures a scene in a physical space 601 in which a user 602 is present. The user 602 in the physical space 601 is the target captured by the depth camera 608 that processes the depth information and/or provides the depth information to a computer, such as computer 610 shown in FIGS. 6A-6E. The depth information is interpreted for display of a visual representation of the user 602, such as an avatar. For example, the depth camera 608 or, as shown, a computing device 610 to which it is coupled, may output to a display 612.

According to one embodiment, image data may include a depth image or an image from a depth camera 608 and/or RGB camera, or an image on any other detector. For example, camera 608 may process the image data and use it to determine the shape, colors, and size of a target. Each target or object that matches the human pattern may be scanned to generate a model such as a skeletal model, a mesh human model, or the like associated therewith. For example, a skeletal model of the user 602, such as that shown in FIG. 5A, may be generated. Using for example, the depth values in a plurality of observed pixels that are associated with a human target and the extent of one or more aspects of the human target such as the height, the width of the head, or the width of the shoulders, or the like, the size of the human target may be determined.

Image data and/or depth information may be used in to identify target characteristics. Such target characteristics for a human target may include, for example, height and/or arm length and may be obtained based on, for example, a body scan, a skeletal model, the extent of a user 602 on a pixel area or any other suitable process or data. The computing system 610 may interpret the image data and may size and shape the visual representation of the user 602 according to the size, shape and depth of the user's 602 appendages. The target characteristics may comprise any other features of the target, such as: eye size, type, and color; hair length, type, and color; skin color; clothing and clothing colors. For example, colors may be identified based on a corresponding RGB image. The depth information and target characteristics may also be combined with additional information including, for example, information that may be associated with a particular user 602 such as a specific gesture, voice recognition information, or the like. The model may then be provided to the computing device 610 such that the computing device 610 may track the model, render an avatar associated with the model, and/or determine which controls to perform in an application executing on the computing device 610 based on, for example, the model.

The system 600 may provide the user 602 with the ability to interact with the onscreen visual representation for modifying the visual representation. For example, the system 600 may track the model of the user 602 and identify a gesture performed by user 602 that corresponds to a modification of the visual representation. The user 602 can gesture to customize the characteristics of the visual representation. For example, the user 602 may customize the avatar by adding hairstyle, skin tone, body build, etc. The user 602 may change eye shape, rearrange facial features, extend limbs, squash or elongate a body part, make the representation skinnier or fatter, taller or shorter, or the like. An avatar may also be provided with clothing, accessories, emotes, animations, and the like. The modification may include the addition, removal, or change in color or size of accessories or clothing, or the like, worn by the avatar. The visual representation may be of another target in the physical space 601, such as another user or a non-human object, or the visual representation may be a partial or entirely virtual object, as described in more detail below. The user 602 may make modifications to any such visual representations. For example, if the visual representation is of a chair in the physical space 601, the user 602 may perform modifications gestures that are recognized to change the characteristics of the chair.

The user 602 may opt for a visual representation that is mapped to the features of the user 602, where the user's 602 own characteristics, physical or otherwise, are represented by the visual representation. The visual representation of the user 602, also called an avatar, may be initialized based on the user's 602 features, such as body proportions; facial features, etc. For example, the skeletal model may be the base model for the generation of a visual representation of the user 602, modeled after the user's 602 proportions, length, weight of limbs, etc. Then, hair color, skin, clothing, and other detected features of the user 602 may be added to the model. The user 602 may customize the model of the user 602 to vary from the detected features.

The visual representation of a target in the physical space 601 can take any form. The visual representation of the target, such as a user 602, may initially be a digital lump of clay that the user 602 can sculpt into desired shapes and sizes. The visual representation may be a combination of the user's 602 features and an animation or stock model. For example, the user 602 may opt for a visual representation that is a stock model provided with the system 600 or application. The user 602 may select from a variety of stock models that are provided by a game application. For example, in a baseball game application, the options for visually representing the user 602 may take any form, from a representation of a well-known baseball player to a piece of taffy or an elephant to a fanciful character or symbol, such as a cursor or hand symbol. The stock model may be specific to an application, such as packaged with a program, or the stock model may be available across-applications or available system-wide.

Whether the visual representation is mapped to the features of the user 602 or not, the user 602 may perform gestures that result in a modification of the visual representation. The gestures in the virtual space may act as controls of an application such as an electronic game, but also correspond to the control of modifications to the display 612. For example, the tracked motions of a user 602 may be used to move an on-screen 612 character or avatar in an electronic role-playing game, to control an on-screen 612 vehicle in an electronic racing game, to control the building or organization of objects in a virtual environment, or to perform any other suitable controls of an application, such as modifying aspects of the display 612. In an example embodiment, the motion in the physical space 601 may be representative of a gesture recognized as a request to modify the visual representation of a target.

Thus, a gesture may be recognized as a request for avatar modification. FIG. 6A depicts an example gesture 603 performed by the user 602a that corresponds to the lengthening of a limb 616a of the user's visual representation 615a, 615b. In this example, the visual representation of the user 602a is an avatar 615a, 615b that was initialized by the user's 602a own physical features. The display 612 is shown in two phases, 612a, 612b, representing the visual representation 615a during modifications and the visual representation 615b after the modification is applied to the avatar. In this example, the user's 602a hair color, eyes, clothing, etc, were detected by the system 600 and applied to the avatar 615a, 615b. The user's gesture 603, which comprises lifting the user's arm to position the elbow at or approximately at the height of the user's 602a shoulder, and then motioning back and forth with the lower portion of the user's arm, from the elbow to the hand. A gesture recognition engine, such as the gesture recognition engine 192 described with respect to FIG. 5B, may compare the user's motion to the gesture filters that correspond to the gestures in a gesture library 190. The user's 602a motion may correspond to a modification gestures 196 in the gestures library 190, for example, that is identified as a limb stretching modification gesture 603.

The gesture 603 depicted in FIG. 6A may correspond to a lengthening of the avatar's 615a, 615b limb 616a that corresponds directly to the limb the user is moving in the physical space 601. For example, the gesture for lengthening a specific limb of an avatar could be a vigorous shaking of that same body part in the physical space. The identification of the avatar's limb to be lengthened may simply be identified as the limb the user 602 chooses to gesture with in the physical space. Thus, the user 602 may perform gestures using the user's body to reflect the body part to modify.

In another example embodiment, shown in FIG. 6B, the user 602b may initialize a modification by using hand 634 control. For example, a user's 602b gesture may comprise opening the hand 634 and floating it over the body part 635 the user 602b wishes to customize. Thus, to initiate the modification of a specific limb or body part 635, the gesture may comprise the user 602b initially floating an open hand 634 over the body part 635 that is to be customized. Following the identity of the limb or body part 635 to be customized, the same gesture 603 shown in FIG. 6A (comprising the motion of the user's arm that results in the lengthening of the avatar's arm) may be used for lengthening the body part 635 identified by the hand control. The gesture 603, or any other modification gesture, may be similarly used for other body parts initialized in the manner shown in FIG. 6B.

An indication may be provided to indicate that a gesture has been recognized that corresponds to a modification or to the initialization of a modification. For example, the indication may be visual or auditory, such as an indicator on the screen or a voice-over, and may indicate that the user is about to perform a modification to a visual representation. In an example embodiment, the indication that an initializing modification gesture has been recognized is the display of a glow over the portion of the visual representation that would be affected by the modification. For example, as shown in FIG. 6B, the user floats his or her hand 634 over the user's leg 635. The gesture is identified as a modification gesture, where the floating of the hand 634 over the user's leg 635 indicates that the user 602b intends to make a modification to the leg 635 of the avatar 617 displayed on the screen 612. As shown on the display 612, the indication that the initialization of the modification gesture has been recognized, and that the modification will be to the avatar's leg, is the display of a glow 618 around the limb of the avatar that will be modified. Following the display of the glow 618, the user 602b may perform a modification gesture that modifies the selected limb 635, such as the modification gesture 603 as shown in FIG. 6A. Because the avatar's 617 leg was identified as the desired body part to modify, the lengthening gesture 603 from FIG. 6A may result in a lengthening of the avatar's leg.

The display device 612a, 612b in FIG. 6A displays the modification to the avatar as a result of the limb stretching modification gesture 603. The user's gesture may cause a one-time modification or the gesture may cause a continuous modification. For example, if the user continuously performs a gesture, the modification that corresponds to the gesture may be applied continuously until the user stops performing the gesture. In the example gesture 603 shown in FIG. 6A, each time the user gestures 603 back and forth with his or her hand, the avatar's arm 616 extends. Thus, a first back and forth gesture 603 may cause the avatar's arm to extend from it's original length, 616a, to a second length, 616b. A second back and forth gesture may cause the avatar's arm to extend from the second length, 616b, to a third length, 616c. The user may continue to perform the gesture until the avatar's arm 616 length has reached the length desired by the user 602a.

In this example, each time the gesture 603 is performed it causes a corresponding step-wise change to the avatar's arm 616, such as from 616a to 616b, to 616c. The amount of change at each step may vary depending on the context, the gesture, the modification, the application, or the like. The resulting modification may depend on how dramatically the gesture is performed. For example, if the user's back and forth gesture 603 in FIG. 6A is done very quickly the avatar's limb, such as the arm 616, may stretch more quickly and/ or the amount of change in length that corresponds to each back and forth gesture 603 may be larger. A faster back and forth gesture 603 may result in a bigger length change from the original length 616a to a second length 616b. If the back and forth motion is small and very quick, the change in length may be applied in smaller increments. Or, a one time back and forth gesture 603 may result in the length change from the original length 616a to the 616c length. Thus, the modification that results from a gesture, such as exemplary gesture 603, may be defined to correspond to how the gesture is performed, such as how long the gesture is performed or how dramatic the motions are that represent the gesture.

In another example, the user 602a may perform a gesture such as gesture 603 once and the modification may continue to occur until the user performs a gesture that completes the modification. For example, the user could perform a single back and forth gesture 603, and the limb of the avatar may begin extending in increments. When the limb 616 of the avatar 615 has reached the desired length, the user 602a may perform a stop modification gesture to stop the modification. For example, the stop modification gesture may be an open hand from the user's outstretched arm that indicates a desire to stop the modification.

In FIG. 6A, display device 612b represents the same display device as 612a, but depicts the avatar 615d at the completion of the modification with a longer arm 616d. Following the modification, the system 600 may continue to map the user's motions to the modified avatar 615. Furthermore, gestures performed by the user 602 may continue to be recognized and control aspects of the system 600 or an executing application through the modified avatar, for example. However, the system 600 may modify the mapping of the user's motion to the avatar to reflect the user's motion as it would translate to the modification, adapting the motion to the characteristics of the avatar. The mapping of the user's motion may not be a literal translation of the user's movement, as the visual representation will be adapted to the modification. For example, the user may change the avatar to have extreme proportions, such as giving the avatar 615 a four foot arm 616d. Then, if the user touches his or her nose in the physical space, the visual representation of that motion may be translated to represent a realistic motion of a four foot arm touching the avatar's nose. Thus, the user's motions may be mapped to the avatar with some added animation to reflect the avatar's modified form.

As modifications are applied to the visual representation, additional animation may be added to the mapped motion depending on the modification and/or the form of the modified avatar. The onscreen character, for example, may have physics-based reactions to the modification. For example, when the motion of a user 602a touching his or her nose is translated into the four foot arm 616d of the avatar 615b touching the avatar's nose, the four foot arm 616d may be displayed with wobbly motion with a depression in the middle of the four foot length, representing the awkwardness of moving a four foot arm and the effects of gravity on such a long limb. If the modification comprises adding weight to the user's avatar, the avatar may display a shift in posture. For example, if the modification adds weight to the avatar's stomach, the avatar may display a change in posture to represent a change in the avatar's center of gravity due to the weight imbalance. The avatar may also respond vocally as a modification is applied to the avatar, such as humorous noises that correspond to a modification. For example, if the modification stretches out the neck of an avatar, the avatar may respond by saying “ow” or “heeeeheee.” In another example, if the user rearranges the avatar's facial features by selecting eyes ears and mouth and positioning them in different spots on the avatar's head, the avatar may respond and say “Where is my nose?” or “I look weird!”

FIG. 6C depicts an example gesture 604 performed by the user 602c that corresponds to a modification of the user's 602c visual representation 619, where the visual representation 619 of the user 602c is in the form of an elephant rather than a representation of the user's detected features. The user's 602c motions may be mapped to the elephant avatar 619, and gestures, such as gesture 604, may provide aspects of control, as described above. Because the visual representation 619 of the user 602b is not a representation of the user's own physical structure, the user's 602c motion may be translated to be consistent with the form that the visual representation 619 takes. In this example, for example, the motion may be translated to be consistent with the motion of an elephant. As described above, the gesture filters 191 may also define gestures that are specific to the form that the visual representation takes. For example, to cause the elephant avatar 619 to walk in the virtual space, the gesture may comprise the same walking motion that would apply when the avatar has the user's features. The walking motion of the elephant avatar 619 may partly map to the user's 602c motion. For example, with respect to the user's walking motion in the physical space, the elephant's left legs may move in response to the user's left leg movement and the elephant's right legs may move in response to the user's right leg movement. However, a human target does not have a trunk, so animation may be added that corresponds to the motion an elephant's trunk would make as an elephant walks. Similarly, there may be particular modification gestures that are applicable to the elephant avatar that would not be applicable to an avatar that represented a human target, such as gestures that move the elephant avatar's trunk. The modifications to the avatar, therefore, may be specific to the form that the avatar takes.

In FIG. 6C, the user 602c is performing a gesture 604 in the physical space 601 that comprises aligning the user's 602 outstretched arm with the user's nose, and then motioning the arm up and down. The gesture 604 is identified as a trunk lengthening gesture. In this example, the trunk lengthening gesture 604 results in an extension of length of the elephant avatar's trunk from length 620a to 620b to 620c.

As described above, the system may continue to map the user's 602c motions to the elephant avatar 619, as modified with the longer trunk, and gestures performed by the user 602c may continue to control aspects of the system or an executing application, for example. However, the system 600 may modify the mapping of the user's 602c motion to the avatar 619 to reflect the user's 602c motion as it would translate to the modification and to the form that the visual representation 619 takes.

In another example, consider if the user were visually represented as a piece of taffy. The user may select to be visually represented by taffy from stock model options, for example, or the user may choose to sculpt himself or herself into a piece of taffy by gesturing in the physical space to form a mound of digital clay into taffy. The user may perform gestures in the physical space that, therefore, map to a piece of taffy. The visual representation of the user's motion may be translated to represent a realistic motion of a piece of taffy. Thus, the user's motions may be mapped to the avatar with some added animation to reflect the avatar's modified form. For example, if the user jumps up and down, the taffy that represents the user may map to the user's motion with added animation to represent what taffy would look like if taffy were jumping up and down. The taffy may be displayed as having flex, stretching out and elongating as the user jumps up and then snapping upwards to correspond to the users “up” motion. Then, to correspond to the users “down” motion, the taffy may be displayed elongating back downwards, where the volume of the taffy gathers towards the floor to correspond to the user's “down” motion, and then the display of the taffy may return to the original taffy shape, where the volume of the taffy becomes balanced again, at the completion of the user's motion.

A particular gesture or gestures may correspond to the erasing of a modification. In some cases, the user may not have desired the modification or does not like the appearance of the avatar following the modification. A gesture may correspond to the erasure of that modification. For example, if the user shown in FIG. 6C performs the trunk lengthening gesture 604, resulting in a lengthening of the trunk of the elephant avatar 619 to the trunk length 620c, the user could perform an erasing gesture. The erasing gesture could cause the visual representation 619 to return to the state of display prior to the last modification gesture or series of modifications gestures. For example, the trunk of the elephant avatar shown in FIG. 6C could return to the second trunk length 620b caused by the last modification gesture or the trunk may return to its first trunk length 620a that was displayed prior to the series of modifications. The erasing gesture may be specific to the system or an application executing on the system 600. For example, the erasing gesture for a particular application may be a waving motion similar to the motion made when holding a chalkboard eraser and erasing a chalkboard. Different applications may have different gestures for modification and for erasing, or the gestures may be common across several applications or be system-wide.

It is noted that the examples above are discussed with respect to a human target in the physical space 601 and a modification of a visual representation of that user, such as the avatar 615 that represents the user 602a in FIG. 6A, or the elephant avatar 619 that is selected for representation of the user 602c in FIG. 6C. However, the same principles and techniques may apply to the modification of another human target or a non-human target in the physical space 601. For example, the target modified may be another user in the physical space 601 or a physical object such as a chair or basketball hoop. The user 602 may perform a gesture that results in a modification to the visual representation of another user or an object in the virtual space.

The virtual space may comprise a representation of a three-dimensional space that a user may affect—say by moving an object—through user input. That virtual space may be a completely virtual space that has no correlation to a physical space of the user—such as a representation of a castle or a classroom not found in physical reality. That virtual space may also be based on a physical space that the user has no relation to, such as a physical classroom in Des Moines, Iowa that a user has never seen or been inside. The virtual space may comprise a representation of some part of the user's physical space. A depth camera that is capturing the user may also capture the environment that the user is physically in, parse it to determine the boundaries of the space visible by the camera as well as discrete objects in that space, and create virtual representations of all or part of that, which are then presented to the user as a virtual space. Thus, it is contemplated that other aspects of the display may represent objects or other users in the physical space.

In an embodiment, the virtual object corresponds to a physical object. The depth camera may capture and scan a physical object and display a virtual object that maps directly to the image data of the physical object scanned by the depth camera. This may be a physical object in the possession of the user. For instance, if the user has a chair, that physical chair may be captured by a depth camera and a representation of the chair may be inserted into the virtual environment. Where the user moves the physical chair, the depth camera may capture this, and display a corresponding movement of the virtual chair.

With respect to the example in FIG. 6D, the non-human object in the physical space 601 is a dog 624. The dog 624 could be a live animal such that the capture device 608 can scan and model a structure of the animal 624. For example, similar to the skeletal model generated in FIG. 5A, a skeletal model of the animal 624 could be generated. Alternately, the dog 624 could be a stuffed animal with a visual representation that corresponds to the image data captured with regards to the stuffed animal 624 in the physical space.

The user 602d may gesture to make modifications to the display of the physical object. For example, the user may touch a chair in the physical space. The capture device can detect the collision of the user's hand with the physical dimensions of the chair. A particular gesture may correspond to a modification of the visual representation of that chair. For example, the user may touch the back of the chair and then motion quickly upwards, moving his or her hand off of the chair and into a space above the chair. The gesture may correspond to a lengthening of the chair back for display purposes. In FIG. 6D, the user 602d is gesturing in the physical space 601 by making a circular motion, gesture 606, with his or her hand above the top of the dog's 624 head. As can be seen on the display device 612, the gesture 606 translates to an enlargement of the visual representation 625 of the dog. In the virtual space, the visual representation of the dog 625 becomes larger than the user's avatar 623.

The user may interact with an actual physical object in the user's physical space that is identified by the capture device and can be displayed in relation to an avatar in the game space as shown in FIG. 6D. Alternately, the props or objects used in a particular application may be displayed on the screen and the user can interact with the objects by positioning himself properly in the physical space to correspond to a location in the game space. For example, if a collection of balls in a bowling ball return were displayed in the game space, a user could make a forward walking motion and turn in the physical space to control the avatar's walking and turning towards the bowling ball return displayed in the game space. By watching the displayed representation of the user, such as an avatar that is mapped to the user's gestures, the user can position himself or herself to make a ball selection.

In FIG. 6E, the user's 602e avatar shares a virtual space with a basketball hoop, where the basketball hoop 622 is virtual only and does not correspond to a physical object in the physical space 601. The user 602e may watch the user's 602e avatar 628 displayed on the screen 612 and position himself such that the avatar 628 is positioned in a desired position with respect to the virtual basketball hoop 622. The user 602e may align himself or herself to the basketball hoop 622 by observing the user's avatar 628 that maps to the user's motion. The user 602e may gesture, illustrated by the motions 605a, 605b, 605c, in the physical space 601 to correspond to a modification of the virtual basketball hoop 622. In this example, the user 602e reaches his or her hand out in front such that the avatar 628 on the screen 612 is in line with the post of the virtual basketball hoop 622. The user 602e makes a clutching motion from a position starting with the fingers extended 605b, and once the user's hand is closed in a first position 605a, the user motions upward with the first 605c. The gesture 605a, 605b, 605c corresponds to a modification of the basketball hoop 622, extending the post of the virtual basketball hoop to 622b.

It is noted that an object in the physical space may have characteristics that are not directly captured for display, but rather simulate aspects of an object that the capture device can capture and scan to display a desired virtual object. The object may have physical characteristics that are only partially representative of a physical object. The physical object may correspond to a displayed virtual object such that interaction with the physical object translates to certain movement in the virtual space. For example, a mat on the floor may include a layout of a balance beam, having dimensions that map, in proportion, to the dimensions of the surface of the balance beam in the virtual space. However, the mat may be laid out on a flat surface such that the user performs the balance beam actions on a flat surface rather than on an actual physical balance beam. A physical object, modified from the desired object to be displayed, may be desirable where the physical object would be too big for the physical space, or is fanciful in nature. In the gymnastics example, it may be desirable to use a mat to simulate the use of a balance beam to eliminate the risk of a user falling off an actual balance beam.

The detected features of a target in the physical space may become part of a profile. The profile may be specific to a particular physical space or a user, for example. Avatar data, including modifications made, may become part of the user's profile. A profile may be accessed upon entry of a user into a capture scene. If a profile matches a user based on a password, selection by the user, body size, voice recognition or the like, then the profile may be used in the determination of the user's visual representation.

History data for a user may be monitored, storing information to the user's profile. For example, the system may detect features specific to the user, such as the user's behaviors, speech patterns, emotions, sounds, or the like. The system may apply modifications to the user's avatar that correspond to the detected features. For example, if the user makes a modification to an avatar and the avatar makes a noise, as described above, the noise may be patterned from the user's speech patterns or may even be a recording of the user's own voice.

User specific information may also include tendencies in modes of play by one or more users. For example, if a user tends to use broad or sweeping gestures in to control a computing environment, elements of the computing or gaming experience may adapt to ignore fine or precise gestures by the user. As another example, if a user tends to use fine or precise motions only, the computing or gaming system may adapt to recognize such gestures utilize more fine or precise gestures in control of the computing environment. As a further example, if, in one handed applications, a user tends to favor one hand over the other, the gaming system may adapt to recognize gestures from one hand and ignore gestures from the other. The user specific information could include age information or predict an age and apply a set of gestures to the user's motions that are consistent with the age or predicted age. For example, if a user is young, the noises made by the avatar may be representative of how a younger person talks and may limit certain words that are not suitable for a young child.

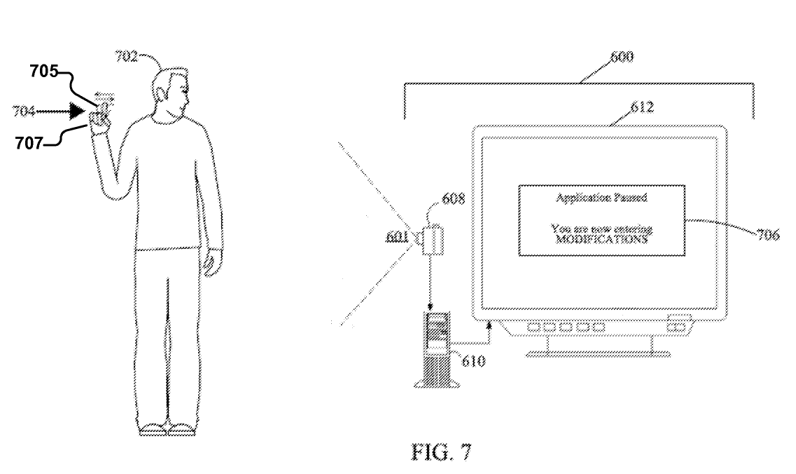

As illustrated in FIG. 7, the recognition of a modifications gesture may break the link between the user's 702 gestures that control aspects of the environment, such as the operating system or an executing application. As shown in FIG. 7, the modification trigger gesture 704 could be defined by the positioning of a user's right hand 707 presented in front of the user's 702 body, with the pointer finger 705 pointing upward and moving in a circular motion. The parameters set for the modification trigger gesture 704 may be used to identify that the user's 702 hand 707 is in front of the body, the user's pointer finger 705 is pointed in an upward motion, and identifying that the pointer finger 705 is moving in a circular motion. The display device 612 may display an indication 706 that the user is pausing the executing application and entering into a modification mode.

The control defined by the gestures may be directed to modifications of a displayed item, such as a visual representation of a target. In the example embodiment shown in FIG. 7, the gesture 704 may be recognized as a trigger for entry into a modification mode. For example, a gesture filter may comprise information for recognizing the modification trigger gesture 704. If the modification trigger gesture 704 is recognized, the application may go into a modification mode 706. A gesture may be recognized for triggering entry into a modification mode. Certain gestures may be identified as a request to enter into a modification mode, where if an application is currently executing, the modification mode interrupts the current state of the application and enters into a modification mode. For example, entry into a modification mode may comprise a pause to an executing application, as shown in FIG. 7. The application can be resumed at the pause point when the user exits the modification mode.

In another example embodiment, the modification mode may not interrupt the application, but may still break the link from the user's control of the application and direct the user's control to a modification of the avatar. Upon recognition of a gesture intended to modify the visual representation or trigger entry into a modification mode, the gesture can cause a change in the form of the visual representation. Thus, the gesture that the user performs to initiate modifications may cause a break in the gesture control of the application, and instead apply gestures performed by the user to the control of characteristics and modifications made to the avatar.

The modification to the visual representation may break the link that displays the user's motions mapping directly to the visual representation of the user. For example, if the user gestures to lengthen a limb by shaking out the user's leg, the avatar's leg may not shake during modification mode, but simply represent the modification of a lengthening limb. In another example embodiment, the modification mode has no effect on the system or executing application and it continues to run as normal while modifications are made.

The system or application may require a specific gesture that indicates entry into a modification mode. Entry into a modification mode that interrupts the application or breaks the link of the user's control of the application may prevent confusion between gestures that are defined for modifications and those gestures that are meant to control other aspects of the executing application. If a distinct modification mode results, similar gestures that apply to control of the executing application may be kept separate from those that apply to modifications. This may prevent frustration on the part of the user if a modification gesture is close to a control gesture, and modifications are applied to the avatar instead of performing the control intended by the user. Also, a separate modification mode, with an entire separate set of gesture filters for modification, may provide for an increase in the number of gestures and types of modifications that can be implemented.

The modification mode may not result in a pause to the application, and the application may continue to execute while the user makes modifications. For example, the example modifications represented by FIGS. 6A-6E may occur while the user is executing an application. Not affecting the execution of the application may be useful where two users are playing a game with each other through a network, each user in their own physical space with their own system, and user #1 enters into a modification mode. If there is no break in the execution, user #2 may see no interruption to the application and user #2 may continue game play. On the other hand, it may be desirable that both systems represent a pause to execution while a modification is being made.

The modification trigger gesture may vary between applications, between systems, between users, or the like. For example, the same gesture in a tennis gaming application may not be the same modification trigger gesture in a bowling game application. Following entry in the modification mode, the system may recognize a plurality of modification gestures, each representing a particular modification. For example, depending on the number of modifications and gestures that are applicable system-wide or for a particular application, it may be desirable to have numerous modification trigger gestures. Each modification trigger gesture may trigger entry into a modification mode, packaged with an independent set of gestures that correspond to the modification mode entered into as a result of the modification trigger gesture. The package could be a system-wide package, an application-specific package, or a gesture-specific package. A different modification trigger gesture could be used for entry into an application-specific modification mode versus a system-wide modification mode.

Once in the modification mode, the user's visual representation may change into a cursor or hand-selection display. The cursor, for example, may correspond to the tracked motions of the user's hand in the physical space, and the user may use gestures for making selections for modification to the avatar based on available options. For example, a tennis gaming application may come with options to select different rackets or a different logo on the avatar's clothes, or the options may be to change the visual representation of the user to have the physique and likeliness of a well-known tennis player. The user's gesture may comprise a clutching motion in line with a visual representation of the modification, such that the modification is applied upon recognition of the clutching motion, for example.

Many modifications may be made, and each may correspond to at least one gesture. A user may wish to sculpt the body of the user's avatar by making the avatar thinner. The motion for a gesture to make the avatar thinner may comprise each hand, right and left, making a patting motion on the user's right and left hip, respectively. The capture device may capture data representative of the motion, and the gesture recognition engine may identify that the motion corresponds to a gesture for avatar modification. The gesture may cause the avatar to get thinner at the waist. If the user continues performs the gesture, the avatar may get thinner and thinner. The user may choose to stop performing the gesture when the avatar is at the point of thinness desired by the user.

A program or application may impose limits as to the visual representations that may be modified. For example, not all physical objects in a scene are mapped to a visual representation for display. Some objects are virtual only and do not represent an object in the physical space. The user may not have the option to make modifications to some of these visual representations of physical or virtual objects. Certain applications may not allow modifications to the user's avatar, such as a game where features of the user's avatar may correspond to a success or failure in the game. In other applications, the number and type of modifications made may depend on a user's skill level. The visual representation of the user may be customized or modified only at selected times or, alternately, be available for customization or modification at any time.

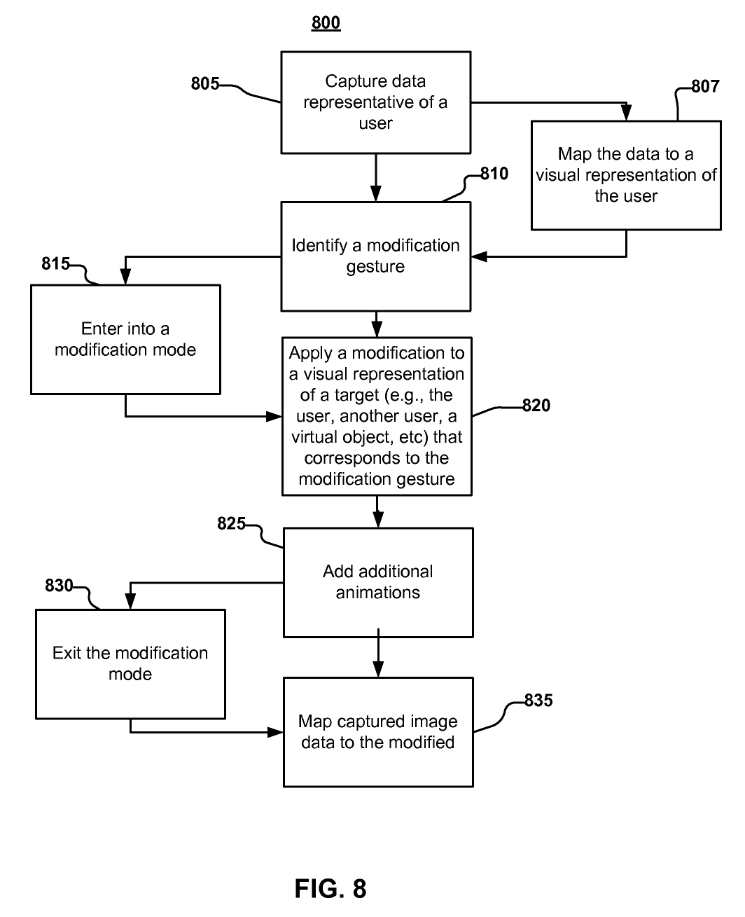

FIG. 8 depicts an example flow diagram of a method for modifying a visual representation. At 805, a system, such as system 10 or system 600 described above, may capture a target or a target's motion in the physical space. The example method 800 may be implemented using, for example, the capture device 20 and/or the computing environment 12 of the target recognition, analysis, and tracking system 10 described with respect to FIGS. 1A-4. The method 800 is described with respect to system 10, but it is contemplated that system 600 or any other device or combination of devices may function to perform the disclosed method for modifying a visual representation.

According to an example embodiment, the target may be a human target, a human target with an object, two or more human targets, or the like that may be scanned to generate a model such as a skeletal model, a mesh human model, or any other suitable representation thereof. The model may then be used to interact with an application that may be executed by the computing environment 12 described above with respect to FIGS. 1A-1B. According to an example embodiment, the target may be scanned to generate the model when an application may be started or launched on, for example, the computing environment 12 and/or periodically during execution of the application on, for example, the computing environment 12. A capture device, such as captured device 20, may receive image data about a scene, the image data may be parsed and interpreted to identify a target in the scene. A series of images may be interpreted to identify motion of the target.

According to one embodiment, a computer-controlled camera system, for example, may measure depth information related to a user's gesture. For example, the target recognition, analysis, and tracking system 10 may include a capture device such as the capture device 20 described above with respect to FIGS. 1A-2. The capture device may capture or observe a scene that may include one or more targets. In an example embodiment, the capture device may be a depth camera configured to obtain depth information associated with the one or more targets in the scene using any suitable technique such as time-of-flight analysis, structured light analysis, stereo vision analysis, or the like. Further, the depth information may be pre-processed, either as a depth image generated from depth data and color data, or even parsed depth image data, such as having skeletal mapping of any user in the image. At 807, the system may display a visual representation of the user.

At 810, the capture device or a computing device coupled to the capture device may recognize a modification gesture from the user's motions. A modification mode may be triggered and entered into, at 815, as a result of the modification gesture. The modification may be applied to a visual representation of a target that corresponds to the modification gesture at 820. For example, if the modification gesture applies to a visual representation of the user, such as an avatar, the modification may be made to the user's avatar. If the modification gesture applies to a visual representation of a virtual object, the modification may be made to the visual representation of the virtual object.

At 825, additional animations may be applied to the modified visual representation. For example, noises may be played during the modification to the visual representation. If the modification gesture caused entry into a modification mode, the user may exit the modification mode at 830. Following the modification of the visual representation of a target, the image data captured with respect to the target may then be mapped to the modified visual representation at 835.

It is noted that the target recognition, analysis, and tracking system 10 is described with regards to an application, such as a game. However, it should be understood that the target recognition, analysis, and tracking system 10 may interpret target movements for controlling aspects of an operating system and/or application that are outside the realm of games. For example, virtually any controllable aspect of an operating system and/or application may be controlled by movements of the target such as the user 18.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Furthermore, while the present disclosure has been described in connection with the particular aspects, as illustrated in the various figures, it is understood that other similar aspects may be used or modifications and additions may be made to the described aspects for performing the same function of the present disclosure without deviating therefrom. The subject matter of the present disclosure includes all novel and non-obvious combinations and sub-combinations of the various processes, systems and configurations, and other features, functions, acts, and/or properties disclosed herein, as well as any and all equivalents thereof. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments.

In addition to the specific implementations explicitly set forth herein, other aspects and implementations will be apparent to those skilled in the art from consideration of the specification disclosed herein. Therefore, the present disclosure should not be limited to any single aspect, but rather construed in breadth and scope in accordance with the appended claims. For example, the various procedures described herein may be implemented with hardware or software, or a combination of both.

What is claimed:

1. A method for applying a modification to a visual representation, the method comprising:
rendering the visual representation;
receiving data of a scene, wherein the data includes data representative of a user's modification gesture in a physical space;
modifying the visual representation based on the user's modification gesture, wherein the modification gesture is a gesture that maps to a control for modifying a characteristic of the visual representation.

2. The method of claim 1, wherein the visual representation rendered is a visual representation of at least one of a virtual object or a target in the physical space.

3. The method of claim 1, further comprising mapping captured motion from the physical space to the modified visual representation.

4. The method of claim 1, wherein the modification gesture triggers entry into a modification mode.

5. The method of claim 1, further comprising recognizing the modification gesture, wherein recognizing the modification gesture comprises:
providing a filter representing at least one modification gesture, the filter comprising base information about the at least one modification gesture;
receiving the image data of a scene that is captured by a camera;
applying the filter to the image data and determining an output from the base information about the at least one modification gesture; and
applying the modification to the visual representation that corresponds to the at least one modification gesture.

6. The method of claim 1, wherein the modification is at least one of behavioral, emotional, physical, a speech pattern, or a voice.

7. The method of claim 1, further comprising receiving the depth image of the physical space, wherein the depth image includes data representative of a human target in the physical space, and the visual representation maps to the human target.

8. The method of claim 1, wherein the visual representation is selected from a plurality of stock models.

9. The method of claim 1, wherein the visual representation is of a user, and the user's modification gesture in the physical space is mapped to the visual representation.

10. The method of claim 1, wherein the modification gesture comprises hand control.

11. The method of claim 1, wherein the modification gesture comprises physical motion of a user's body part to be modified.

12. The method of claim 1, wherein rendering a visual representation comprises rendering a visual representation of a user having at least detected characteristics of the user.

13. The method of claim 10, wherein the detected characteristic is a physical characteristic of the user in the physical space that is captured by a capture device.

14. A system for applying a modification to a visual representation, the system comprising:
a camera component, wherein the camera component receives data of a scene, wherein the data includes data representative of a user's modification gesture in a physical space; and
a processor, wherein the processor executes computer executable instructions, and wherein the computer executable instructions comprise instructions for:
rendering the visual representation;
modifying the visual representation based on the user's modification gesture, wherein the modification gesture is a gesture that maps to a control for modifying a characteristic of the visual representation.

15. The system of claim 14, further comprising a display device for displaying the visual representation and the modified visual representation.

16. The system of claim 14, further comprising mapping captured motion from the physical space to the modified visual representation.

17. The system of claim 14, wherein the visual representation rendered is of at least one of a virtual object or a target in the physical space.

18. The system of claim 14, further comprising a gesture recognition engine, wherein the gesture recognition engine:
provides a filter representing at least one modification gesture, the filter comprising base information about the at least one modification gesture;
receives the image data of a scene that is captured by a camera;
applies the filter to the image data and determining an output from the base information about the at least one modification gesture; and
applies the modification to the visual representation that corresponds to the at least one modification gesture.

19. The system of claim 14, wherein the capture device receives depth image data of the physical space, wherein the depth image data includes data representative of a human target in the physical space, and the visual representation maps to the human target.

20. The system of claim 14, wherein the visual representation is of a user, and the user's modification gesture in the physical space is mapped to the visual representation.

21. The system of claim 14, wherein the modification gesture comprises at least one of hand control or physical motion of a user's body part to be modified.

22. The system of claim 14, wherein rendering a visual representation comprises rendering a visual representation of a user having at least detected characteristics of the user.
